(19) United States
(12) Patent Application Publication
(10) Pub. No.: US 2005/0152353 A1
(43) Pub. Date: Jul. 14, 2005

(54) Quality of service request correlation

(76) Inventor: Alban Couturier, Chatillon (FR)

Correspondence Address: SUGHRUE MION, PLLC, 2100 PENNSYLVANIA AVENUE, N.W., SUITE 800, WASHINGTON, DC, 20037, US

(21) Appl. No.: 10/505,227

(22) PCT Filed: Feb. 14, 2003
(86) PCT No.: PCT/FR03/00476

(30) Foreign Application Priority Data
Feb. 21, 2002 (FR) 02/02208

(51) Int. Cl. H04L 12/28; H04L 12/56

(52) U.S. Cl. 370/389; 370/395.21

(57) ABSTRACT

The invention concerns s a device for controlling (CD) a data network (N), comprising means for receiving quality of service requests, corresponding to microflows, and means for communicating with an admission controller (AC) for booking resources required in the data network. The invention is characterized in that it isi provided with means for correlating the quality of service requests, and in that it transmits a single resource booking request for all the correlated quality of service requests to the admission controller.

The present invention relates to data networks, in particular to telephone networks. It relates to managing quality of service in telecommunication networks. It applies particularly well to new generation networks, i.e. networks providing different kinds of services, for example transmission of voice, video, data, etc. This kind of network is based on protocols of the Transport Control Protocol/Internet Protocol (TCP/IP) family, for example.

The invention relates more precisely to the phase of creating a session of one of these services.

Certain networks, such as the Internet, have been designed to convey data but not voice or video, for example. Within the Internet, data is transmitted in the form of packets, each packet being routed to its destination independently of the other packets. Each packet is conventionally associated with a 5-tuple: protocol used, sender address and port, addressee address and port.

The term “microflow” usually refers to a set of packets that have the same 5-tuple, or at least the same 4-tuple if the packets do not mention the sender port. Hereinafter, the term microflow encompasses both these possibilities.

Certain services necessitate the explicit reservation of resources within the network. This reservation of resources guarantees a quality of service for the service session.

This reservation of resources may imply controlling certain elements of the network (for example, “provisioning” or parametering those elements). This control may consist in actually reserving resources in the nodes (or routers), authorizing the transmission of the microflows concerned at an edge router, or even merely calculating if the configuration of the network elements and their use enable a new microflow to be transported (this mechanism is usually called admission control).

To this end, there is generally associated with the data network a network control device responsible in particular for admission control and, where applicable, for effective implementation of provisioning or parametering in the managed network.

This first step generally consists in administrative verification of rights, i.e. primarily in answering the question: does the requested service session correspond to what is authorized for the client and for the service provider?

The second step, executed if the answer to the above question is favorable, then consists in controlling the network element or elements to enable correct transmission of the microflows to which the service session relates.

In order to determine which network elements are impacted on, the network management system must determine the path within the network that will be taken by the data packets corresponding to the service session.

However, the same service session may imply a plurality of microflows of packets. For example, a videophone service between two parties A and B necessitates four microflows of packets:
a microflow from A to B transporting voice data,
a microflow from A to B transporting video data,
a return microflow from B to A transporting voice data, and
a return microflow from B to A transporting video data.

This being the case, the network control systems determine the path four times and trigger the network element control process four times.

The object of the invention is to avoid this redundancy of the tasks effected by the network control system.

To this end, the invention provides a system for controlling a data network, comprising means for receiving quality of service requests corresponding to microflows of packets and control means for controlling elements of said data network, which system is characterized in that it comprises means for correlating the quality of service requests and the control means effect said control once only for all the correlated quality of service requests.

The invention also provides a control device of a data network, comprising means for receiving quality of service requests corresponding to microflows and means for communicating with an admission controller (AC) for reserving the required resources within said data network, characterized in that it comprises means for correlating the quality of service requests and transmits a single resource reservation request to the admission controller for all the correlated quality of service requests.

The invention further provides an admission controller associated with a domain of a data network, comprising means for receiving a single resource reservation request corresponding to correlated quality of service requests and control means for controlling elements of said domain, characterized in that it further comprises means for communicating said single resource reservation request to the admission controller associated with a second domain of said data network.

Thus the determination of the path and the controlling of the network elements may be triggered once only for all the microflows corresponding to correlated quality of service requests of a service session. This therefore minimizes the resources necessary for processing these tasks within the system or network control device. As a result, the latter may be more efficient at processing quality of service requests or resource reservation requests and/or may be specified more modestly compared to the prior art.

In one embodiment of the invention, the network elements may be controlled “atomically” for all correlated resource reservation requests.

This avoids a further drawback of the prior art control systems: if a resource reservation request corresponding to a service session can not be satisfied (for example because sufficient resources are not available), then all the other resource reservation requests corresponding to the same service session must be considered or reconsidered. If the policy imposed on the network control device is to set up the microflows of packets corresponding to a service session on an “all or nothing” basis, then the network control device must eliminate the effects of control operations previously effected for this service session (this mechanism is known as rollback). Rollback clearly represents a penalty since it generates unnecessary operations.

Accordingly, one embodiment of the invention alleviates this drawback by processing all resource reservation requests atomically.

The invention and other advantages of the invention will become more clearly apparent in the light of the following description with reference to the appended figures.

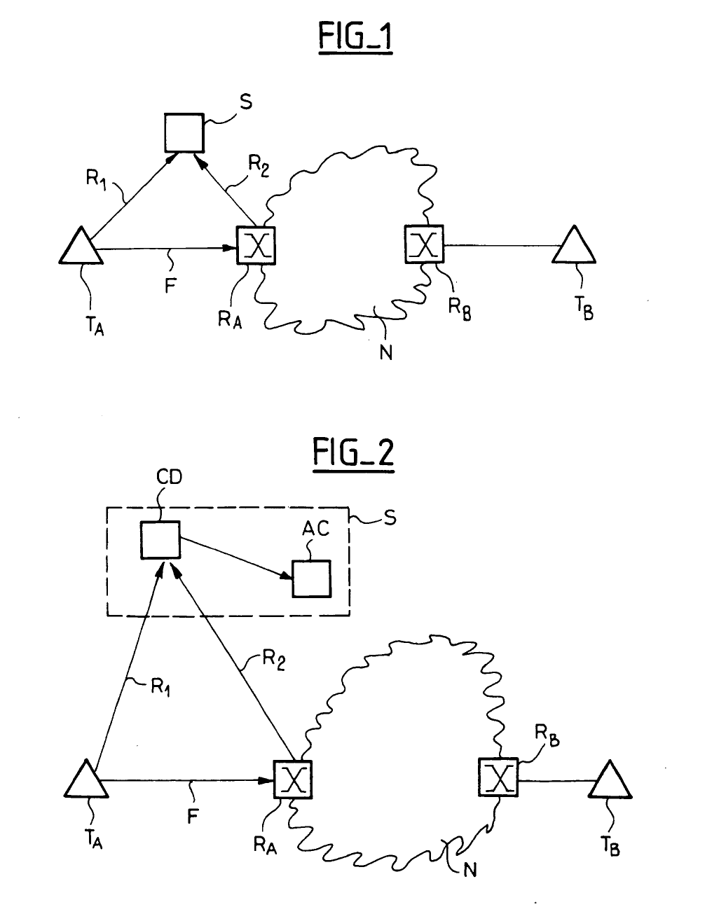

FIG. 1 shows a first embodiment of the invention.

FIG. 2 shows a second embodiment of the invention.

FIG. 1 shows one example of a data network. A terminal T_{A} wishes to set up a service session with a terminal T_{B} via the data network N. This service session is associated with at least the transmission of one or more data microflows F from the terminal T_{A}. To enable the reservation of resources for each data microflow, a resource reservation request is transmitted to the control system responsible for managing the data network N.

For example, two microflows of packets may be associated with the same service session, namely one microflow of packets transporting voice and one microflow of packets transporting video.

The control system S comprises means for correlating resource reservation requests transmitted to it.

Correlation may be effected in particular by comparing the 5-tuples identifying the two microflows.

It may more particularly be effected by comparing the IP addresses of the sender and the addressee; if these are identical, then the two microflows are considered to be correlated. Correlated microflows may be referred to as “adjacent microflows” hereinafter.

In one embodiment of the invention, the control system S may anticipate acceptance of service session set-up: if the service session is actually set up, then there will be two additional microflows of packets in transit in the network N, for example:
one microflow of packets transporting voice, emanating from the terminal T_{B} and terminating at the terminal T_{A}, and
one microflow of packets transporting video, emanating from terminal T_{B} and terminating at terminal T_{A}.

Given that there is a high probability that these return microflows of packets will have to be set up, the control system S may be adapted to anticipate this. This is particularly beneficial when the control system considers only one domain, i.e. when it is relatively certain that the return microflows will take the same path.

The control system S also comprises control means for actually controlling the network equipments concerned (i.e. for reserving the necessary resources).

This control step may be preceded by an admission control step. The admission control step consists in verifying that the sender of the quality of service requests has the administrative rights to effect this reservation of resources.

According to the invention, the admission control step may be effected once only for all adjacent (i.e. previously correlated) quality of service requests.

The control means of the control system S then execute a step of determining the path within the network N that the microflows of packets will take. This is done by simulating the routing that will be effected by the elements of the network N through which the flows of packets pass.

According to the invention, this simulation is also effected once only for all adjacent microflows.

In one embodiment of the invention, the network elements are controlled (for the actual reservation of resources) atomically; the resources are reserved if and only if all the resource reservation requests may be satisfied.

In another embodiment, although the reservation of resources is effected only once, only some of the quality of service requests may be satisfied. Certain microflows may be transmitted correctly whereas other microflows adjacent the first may not be transmitted correctly or at all.

There may be provision for one or other of these mechanisms to be selected by setting a parameter.

Each quality of service request may be associated with a requested bandwidth.

In one embodiment of the invention, the control system S may be adapted to process the situation in which the various microflows of correlated packets must share the same bandwidth. For example, two adjacent microflows may share a bandwidth of 100 kbit/s, which is particularly beneficial in the case of a terminal having two microflows transmitting up to 100 kbit/s alternately.

In one embodiment of the invention, the transmission of the results from the correlation means to the control means may be described by means of an interface description language (IDL) as defined by the Object Management Group (OMG).

There follows one example of this kind of IDL interface:

| enum mode {AllOrNothing, BestEffort} | |
|---|---|
| struct microflow{t_mfID | id; |

| | |
|---|---|
| t_IPaddress | originIP; |
| t_PortNumber | portOrig; |
| t_IPaddress | destIP; |
| t_PortNumber | portDest; |
| int | Protocol; |
| t_Qos | qos}; |

typedef sequence<microflow> AdjacentMicroFlowList; //same IP

addresses

resultReservation reserveQoS (inAdjacentMicroFlowList list,

in Mode mode)
raises (ReservationException);

FIG. 2 shows a second embodiment of the invention. In this embodiment the control means are remote from the correlation means.

FIG. 2 comprises most of the elements from FIG. 1.

However, the control system S is divided between a control device CD comprising the correlation means and an admission controller AC comprising the control means.

The control device CD may be a soft switch (software switch), an SIP proxy device, etc.

The usual role of the control device CD is to serve as the point of entry for resource reservation requests concerning the network N and to effect administrative admission control as described above. According to the invention, it further comprises means for correlating resource reservation requests. These correlation means operate in exactly the same way as the correlation means described for the embodiment shown in FIG. 1.

The admission controller AC may take the form of an independent software module on the same processing system as the control device CD or a remote system. They may communicate by means of a communication protocol.

To this end the control device CD is provided with means for communication with the admission controller AC. It is therefore able to transmit to it a single resource reservation request for all the correlated resource reservation requests.

In the particular case of implementation under the 3GPP standards, the control device may be a proxy call session control function (P-CSCF) as described in the technical specification “3GPP TS 23.225, IP Multimedia Subsystem”. The administration controller AC may be the policy control function (PCF).

In one embodiment of the invention, the admission controller AC and the control device CD may communicate by means of the COPS protocol as defined in RFC 2748 of the Internet Engineering Task Force (IETF). Any other signaling protocol may be used, of course, in particular that issued by the Next Step In Signaling (NSIS) working group of the IETF.

The protocol used may provide for a parameter to specify if network element control must be effected atomically or not.

In the context of a multidomain network, each domain may be associated with an admission controller. In this case, there may be provision for the admission controllers to communicate with each other.

The first admission controller, i.e. the one that has received a quality of service request corresponding to correlated microflows from a control device CD, may then communicate that single request to the admission controller concerned. It is communicated once only for all the correlated microflows.

The admission controllers then have means for communicating the single resource reservation request to the admission controller associated with a second domain of the data network.

The interface and/or the protocols are implemented to enable communication between the admission controllers. This protocol may be a protocol issued by the Next Step In Signaling (NSIS) working group of the IETF previously referred to, for example.

1. System for controlling a data network, comprising means for receiving quality of service requests corresponding to microflows of packets and control means for controlling elements of said data network, which system is characterized in that it comprises means for correlating the quality of service requests and the control means effect said control once only for all the correlated quality of service requests.

2. Control system according to claim 1, in which the correlation is effected by comparing the 5-tuples of said microflows.

3. Control system according to claim 2, wherein the correlation is effected by comparing the addresses of the sender and the addressee.

4. Control system according to claim 1, wherein said reservation means form a software module remote from said correlation means and communicating therewith by means of a communication protocol.

5. Control system according to any preceding claim, wherein said network elements may be monitored atomically.

6. Control system according to claim 1, wherein the control means are adapted to perform admission control prior to controlling said network elements.

7. Control system according to claim 1, wherein the control means are such that said correlated reservation requests share the same bandwidth.

8. Control system according to claim 1, wherein the correlation means are adapted to anticipate flows of return packets and to consider them to determine the correlated resource reservation requests.

9. Control device (CD) of a data network (N), comprising means for receiving quality of service requests corresponding to microflows and means for communicating with an admission controller (AC) for reserving the required resources within said data network, characterized in that it comprises means for correlating the quality of service requests and transmits a single resource reservation request to the admission controller for all the correlated quality of service requests.

10. Control device according to claim 9 wherein the correlation is effected by comparing the 5-tuples of said microflows.

11. Control device according to claim 10, wherein the correlation is effected by comparing the addresses of the sender and the addressee.

12. Control device according to claim 9, wherein said correlated quality of service requests may share the same bandwidth.

13. Control device according to claim 9, wherein the correlation means are adapted to anticipate return microflows and to consider them for determining the correlated quality of service requests.

14. Admission controller associated with a domain of a data network (N), comprising means for receiving a single resource reservation request corresponding to correlated quality of service requests and control means for controlling elements of said domain, characterized in that it further comprises means for communicating said single resource reservation request to the admission controller associated with a second domain of said data network.
